(19) United States
(12) Patent Application Publication
(10) Pub. No.: US 2013/0165580 A1
(43) Pub. Date: Jun. 27, 2013

(54) Sedimentation-Stabilized Water-Based Pigment Preparations

(71) Applicant: Hendrik Ahrens, Kriftel (DE)

(72) Inventor: Hendrik Ahrens, Kriftel (DE)

(73) Assignee: CLARIANT FINANCE (BVI) LIMITED, Tortola (VG)

(21) Appl. No.: 13/820,379

(22) PCT Filed: Aug. 17, 2011
(86) PCT No.: PCT/EP2011/004137

§ 371 Date: Mar. 1, 2013

(30) Foreign Application Priority Data
Sep. 4, 2010 (DE) 10 2010 044 406.5

(51) Int. Cl. C09D 139/04

(52) U.S. Cl. CPC C09D 139/04
USPC 524/547

(57) ABSTRACT

The invention relates to aqueous pigment preparations, containing (A) 1 to 75 wt % of an organic or inorganic white or colored pigment or a mixture of various organic or inorganic white or colored pigments, (B) 0.01 to 40 wt % of one or more wetting and dispersing additives, (C) 0.01 to 5 wt % of a water-soluble or water-swellable, cross-linked copolymer containing 50 to 98.99 wt % of acrylamidoalkylsulfonic acid and salts thereof of the formula (I), 1 to 49.99 wt % of cyclic N-vinylcarboxamides of the formula (II), and 0.01 to 8 wt % of a cross-linking monomer having at least 2 olefinically unsaturated units, wherein R is a hydrogen atom or a methyl group, A is a linear or branched alkylene group having 1 to 8 carbon atoms, M is a hydrogen atom, ammonium, or an alkali metal ion, and n is an integer from 2 to 9.

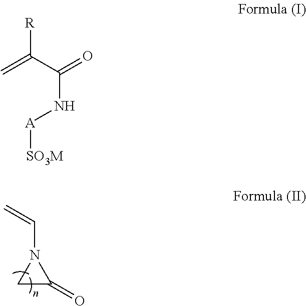

The present invention relates to water-based pigment preparations, a process for production thereof, their use for coloring macromolecular materials of any kind, for example fiber materials, paper pulp coloration, coatings, paints, inks and their use for printing two-dimensional sheet materials such as paper, card, plastics, textiles and leather for example.

Macromolecular materials, especially inks and paints, are colored with aqueous pigment preparations comprising organic or inorganic pigments. The pigments are used in a concentration range of 1 to 75 wt %, depending on the coloring strength desired for the pigment preparations. Preferred pigment preparations for deep, full hues are highly concentrated, preferably at a pigment content of not less than 20 wt %, and for light hues are of low concentration at a pigment content of preferably less than 20 wt %. Generally, the viscosity of aqueous pigment preparations can be observed to increase with the pigment concentration. The low viscosity at a low pigment content can cause pigment sedimentation. Antisettling agents or rheology modifiers are added to aqueous pigment preparations to control sedimentation.

Aqueous pigment preparations typically contain pigments, wetting and dispersing agents and water and also, optionally, customary pigment-preparation auxiliaries such as, for example, additionally solvents, humectants, preservatives, defoamers, pH regulators and rheology modifiers.

Customary antisettling agents and rheology modifiers are gelatin derivatives, cellulose derivatives such as, for example, methylcellulose, hydroxyethylcellulose ether, methoxyethylcellulose ether, methoxypropylcellulose ether, polyvinylpyrrolidone and polyvinyl alcohol, hydrophobically modified urethane thickeners, alkali-soluble acrylate thickeners or hydrophobically modified alkali-soluble acrylate thickeners.

Further inorganic antisettling agents and rheology modifiers are amorphous silicates, sheet-silicates such as bentonites and hydrophobically modified sheet-silicates.

One disadvantage with these customary rheology modifiers is either the incompatibility with organic or inorganic pigments or the deficient thickening performance. Evidence of incompatibility is that, although the rheology modifiers do swell in water and produce a high viscosity, they do not do so in aqueous pigment preparations, in which the viscosity remains at a low level despite large amounts of rheology modifier being added. A further disadvantage of customary rheology modifiers is the long period of secondary swelling. In the course of storage, the aqueous pigment preparations become more and more viscous over time to the point of turning solid in the worse case. This thixotropic behavior should ideally be avoided. There are again other rheology modifiers—such as polyvinyl alcohol, hydrophobically modified urethane thickeners, alkali-soluble acrylate thickeners or hydrophobically modified alkali-soluble acrylate thickeners—which are unsuitable because thickener performance is inadequate or very high amounts of rheology modifier have to be added. Inorganic rheology modifiers have the disadvantage that they can have an adverse influence on the gloss of ink films.

Recently, a novel class of water-soluble or water-swellable rheology modifiers has been developed on the basis of acrylamidoalkylsulfonic acids.

EP 0816403A2 describes the synthesis of acrylamidoalkylsulfonic acids and salts thereof for the synthesis of crosslinked copolymers and their use as thickeners.

US-2001029287A1 discloses the use of N-vinylcarboxamides as monomers for polymerizing water-soluble or water-swellable crosslinked copolymers and their use in cosmetic formulations.

DE 10127876A1 discloses compositions of at least one water-soluble or water-swellable copolymer formed by free-radical polymerization of acryloyldimethyltauric acid or acryloyldimethyl taurates and further monomers and their use as thermoassociative thickeners.

WO-9800094A1 discloses the use as thickeners for cosmetic products of crosslinked copolymers comprising acrylamidomethylpropanesulfonic acid.

The problem addressed by the present invention was that of producing stable and flowable aqueous pigment preparations that have prolonged resistance to sedimentation of the pigments used.

It was found that water-soluble or water-swellable crosslinked copolymers comprising acrylamidoalkylsulfonic acid and/or salts thereof are very useful as antisettling agents for aqueous pigment preparations and provide good, flowable pigment preparations.

The invention accordingly provides aqueous pigment preparations for coloration of inks and paints, comprising
(A) 1 to 75 wt % of an organic or inorganic white or color pigment or of a mixture of various organic or inorganic white or color pigments,
(B) 0.01 to 40 wt % of one or more wetting and dispersing additives,
(C) 0.01 to 5 wt % of a water-soluble or water-swellable crosslinked copolymer comprising 50 to 98.99 wt % of acrylamidoalkylsulfonic acid and its salts of formula (I), 1 to 49.99 wt % of cyclic N-vinyl-carboxamides of formula (II) and 0.01 to 8 wt % of a crosslinking monomer having two or more olefinically unsaturated units,

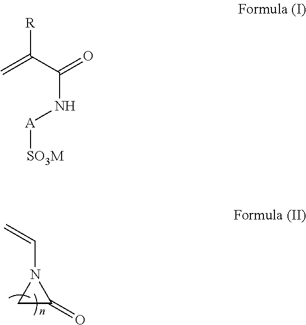

where
R is a hydrogen atom or a methyl radical,
A is a linear or branched alkylene radical with 1 to 8 carbon atoms,
M is a hydrogen atom, ammonium or an alkali metal ion,
n is an integer from 2 to 9,
(D) optionally 0 to 2 wt % of defoamers,
(E) optionally 0 to 2 wt % of biocides,
(F) optionally 0 to 20 wt % of further auxiliaries which are customary for the production of aqueous pigment preparations and selected from solvents, humectants, pH regulators, preservatives, defoamers and rheology modifiers, and
(G) water.

The pigment preparations of the present invention are stable in shearing, to drying out and in storage, foam very little, if at all, in use, and possess an excellent rheology.

Component (A) of pigment preparations according to the present invention is a finely divided organic or inorganic white or color pigment or a mixture of various organic and/or inorganic pigments. The pigments can be used in the form of the water-moist presscake as well as dry powder.

Useful organic pigments include monoazo, disazo, laked azo, β-naphthol, Naphthol AS, benzimidazolone, fused disazo, azo metal complex pigments and polycyclic pigments such as, for example, phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

In addition, the pigments used to produce the preparations should be in a very fine state of subdivision in that preferably 95% and more preferably 99% of the pigment particles have a particle size 500 nm.

An exemplary selection of particularly preferred organic pigments are carbon black pigments, for example gas or furnace blacks; monoazo and disazo pigments, especially the Colour Index pigments Pigment Yellow 1,

Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; p-naphthol and Naphthol AS pigments, especially the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, especially the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, especially the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, especially the Colour Index pigments Pigment Yellow 139 or Pigment Yellow 173; phthalocyanine pigments, especially the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, especially the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, especially the Colour Index pigments Pigment Red 169, Pigment Blue 56 or Pigment Blue 61; diketopyrrolopyrrole pigments, especially the Colour Index pigments Pigment Red 254.

Examples of useful inorganic pigments are titanium dioxides, zinc sulfides, iron oxides, chromium oxides, ultramarine, nickel or chromium antimony titanium oxides, cobalt oxides, mixed oxides of cobalt and of aluminum, bismuth vanadates and also blend pigments.

Component (B) of pigment preparations according to the present invention is a wetting and dispersing additive designed to wet the pigment surface with water and to disperse the wetted pigment. The wetting and dispersing additive serves to lower the dispersion viscosity to form a flowable, low-viscosity liquid or viscous paste. Wetting and dispersing additives consist of amphiphilic molecules having one or more groups with pigment affinity and one or more water-soluble groups. Dispersing additives of the surfactant type additionally lower the surface tension of water to <45 mN/m in a 0.5% aqueous solution.

Useful wetting and dispersing additives include nonionic surfactants from the group of alkylphenol polyethylene glycol ethers, styrene-substituted phenol polyethylene glycol ethers, alkyl polyethylene glycol ethers, fatty acid polyethylene glycol ethers, fatty acid polyglycosides, alkyl polyalkyl glycol ethers of C₈-C₂₂ alcohols which have been reacted with ethylene oxide and propylene oxide in blockwise fashion, endcapped alkyl ethoxylates of C₈-C₂₂ alcohols which have been reacted with ethylene oxide and etherified with methyl chloride, butyl chloride or benzyl chloride, ethylene/propylene glycol block copolymers, sorbitan ester polyethylene glycol ethers and fatty alcohols block-reacted with styrene oxide and ethylene oxide.

Useful wetting and dispersing additives further include anionic surfactants from the group of sodium, potassium and ammonium salts of fatty acids, sodium alkylbenzenesulfonates, sodium alkylsulfonates, sodium olefin-sulfonates, sodium polynaphthalenesulfonates, sodium dialkyl diphenyl ether disulfonates, sodium, potassium and ammonium alkylsulfates, sodium, potassium and ammonium alkyl polyethylene glycol ether sulfates, sodium, potassium and ammonium alkyl phenol polyethylene glycol ether sulfates, sodium, potassium and ammonium mono- and dialkyl sulfosuccinates and monoalkyl polyoxyethyl sulfosuccinates, and also alkyl polyethylene glycol ether phosphoric mono-, di- and triesters and mixtures thereof and alkylphenol polyethylene glycol ether phosphoric mono-, di- and triesters and mixtures thereof, and also sodium, potassium and ammonium salts thereof, alkyl polyethylene glycol ether carboxylic acids and sodium, potassium and ammonium salts thereof, acid sulfuric esters and phosphoric esters of styrene-substituted phenol ethoxylates, styrene-substituted phenol polyethylene glycol ether carboxylic acids and sodium, potassium and ammonium salts thereof, sodium fatty acid isethionates, sodium fatty acid methyltaurides and sodium fatty acid sarcosides.

Useful wetting and dispersing additives further include water-soluble polymers of acrylic acid, methacrylic acid, maleic acid, fumaric acid and ammonium and alkali metal salts thereof, alkoxylated acrylic and methacrylic acid and their copolymers of acrylic and methacrylic esters, e.g., methyl acrylate, methyl methacrylate, butyl acrylate, butyl methacrylate, higher alkyl acrylates and methacrylates, hydroxypropyl acrylate, hydroxypropyl methacrylate, styrene. These water-soluble polymers are particularly suitable for inorganic pigments.

Further suitable wetting and dispersing agents for organic pigments comprise at least one or more hydrophobic moieties with pigment affinity and at least one or more hydrophilic, water-soluble moieties.

Component (C) of aqueous pigment preparations according to the present invention comprises water-soluble or water-swellable crosslinked copolymers prepared by free-radical polymerization of acrylamidoalkyl-sulfonic acid and its salts of formula (I) with cyclic N-vinylcarboxamides of formula (II) and crosslinking monomers having two or more olefinically unsaturated units,

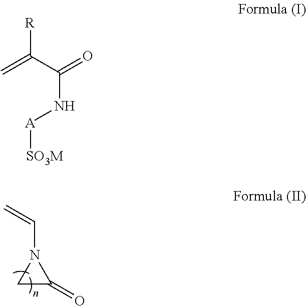

where

R is a hydrogen atom or a methyl radical,

A is a linear or branched alkylene radical with 1 to 8 carbon atoms,

M is a hydrogen atom, ammonium or an alkali metal ion,

n is an integer from 2 to 9.

In a preferred embodiment, A is an alkylene group of 2 to 5 carbon atoms.

In a further preferred embodiment, n is 3, 4 or 5.

In a preferred embodiment, 50 to 98.99 wt % of acrylamidoalkylsulfonic acid and its salts of formula (I), 1 to 49.99 wt % of cyclic N-vinylcarboxamides of formula (II) and 0.01 to 8 wt % of crosslinking monomers are free-radically polymerized.

In a further preferred embodiment, the crosslinking monomer conforms to formula (III)

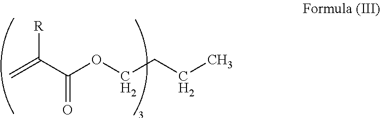

where R is a hydrogen atom or a methyl group.

It is particularly preferable to use trimethylolpropane triacrylate as crosslinking monomer. Using the water-soluble or water-swellable copolymers serves to increase the viscosity of the aqueous pigment preparation and reduces or completely stops pigment sedimentation.

Component (D) consists of defoamers selected from the classes of mineral oil defoamers and emulsions thereof, silicone oil defoamers and silicone oil emulsions, polyalkylene glycols, polyalkylene glycol fatty acid esters, fatty acids, comparatively polyhydric alcohols, phosphoric esters, hydrophobically modified silica, aluminum tristearate, polyethylene waxes and amide waxes.

Component (E) consists of pot preservatives for stabilizing the aqueous preparations and to prevent the uncontrolled growth of bacteria, algae and fungi. Useful biocides include formaldehyde, formaldehyde-detaching components, methylisothiazolinone, chloromethylisothiazolinone, benzisothiazolinone, bronopol, dibromodicyanobutane and titanium dioxide coated with silver chloride.

Components (F) are further auxiliaries suitable for producing aqueous pigment preparations, such as solvents, humectants, pH regulators, preservatives, defoamers and rheology modifiers.

Examples of suitable solvents that also act as humectants are mono-, di- or triethylene glycol, mono-, di- or tripropylene glycol, methyl, ethyl, propyl, butyl or higher alkyl polyalkylene glycol ethers with 1, 2, 3 or more ethylene glycol or propylene glycol units such as, for example, methoxypropanol, dipropylene glycol monomethyl ether, tripropylene glycol monomethyl ether, ethylene glycol monobutyl ether, diethylene glycol monobutyl ether, butyl polyethylene glycol ether, propyl polyethylene glycol ether, ethyl polyethylene glycol ether, methyl polyethylene glycol ether, dimethyl polyethylene glycol ether, dimethyl polypropylene glycol ether, glycerol ethoxylates having a molecular weight of 200 to 20 000 g/mol, pentaerythritol alkoxylates or further ethoxylation and alkoxylation products and random or block copolymers prepared by addition of ethylene oxide and/or propylene oxides onto mono- and polyhydric alcohols.

Suitable assistants for the aqueous pigment preparations of the present invention further include water-soluble organic or hydrotropic substances which may also serve as solvents, are for example formamide, urea, tetramethylurea, ε-caprolactam, glycerol, diglycerol, polyglycerol, N-methylpyrrolidone, 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate, sodium butyl monoglycol sulfate.

Useful pH regulators include organic or inorganic bases and acids. Preferred organic bases are amines, for example ethanolamine, diethanolamine, triethanolamine, N,N-dimethylethanolamine, diisopropylamine, aminomethylpropanol or dimethylaminomethylpropanol. Preferred inorganic bases are sodium hydroxide, potassium hydroxide, lithium hydroxide or ammonia.

Water used as component (G) to produce the aqueous pigment preparations of the present invention is preferably used in the form of distilled or demineralized water. Drinking water (tap water) and/or water of natural origin can also be used. Water is preferably present in the aqueous pigment preparation of the present invention ad 100 wt %.

The pigment preparations of the present invention are particularly useful for formulating light-colored, low-pigmented tinting pastes. Tinting pastes of low pigment concentration are used to formulate light hues for paints and inks. Dispersion viscosity is generally very low due to the low pigment concentration, and this leads to pigment sedimentation.

Particularly pigments of high density have an increased propensity to sediment. One explanation for the pronounced sedimentation propensity of heavy pigments is supplied by the Stokes equation

$${V}_{p} = \frac{2 {r}^{2} g ( {ρ}_{p} - {ρ}_{f} )}{g η}$$

where

r is the pigment particle radius,

g is the acceleration of gravity,

ρₚ is the pigment density,

ρ_{f} is the density of water,

η is the viscosity of the pigment preparation, and

Vₚ is the settling rate of the pigment particle.

This formula reveals that the settling rate of pigments is inversely proportional to the viscosity of the pigment preparation and directly proportional to the density difference between pigment and solvent. Heavy pigments therefore have an enhanced propensity to sediment. Increased viscosity slows the rate of settling.

The tendency of pigments to sediment increases with increasing pigment density:

Pigment densities:

Organic azo and polycyclic pigments: 1.4-1.6 g/cm³

Phthalocyanine pigments and carbon blacks: 1.7-2.0 g/cm³

Inorganic fillers and pigments of low color strength: 2.0-4.0 g/cm³

Titanium dioxides: 4.0-4.5 g/cm³

Iron oxides: 4.0-5.0 g/cm³

Other inorganic pigments, for example chromium oxide green, cobalt blue, bismuth vanadate: 4.0-8.0 g/cm³

Sedimentation can be reduced or completely prevented by using the water-soluble or water-swellable crosslinked copolymers.

A further aspect of aqueous pigment preparations according to the present invention is preparations having a viscosity of 10 to 10 000 mPas, preferably 50 to 5000 mPas and more preferably 100 to 1000 mPas, as measured with a Brookfield viscometer. Other methods of measurement such as the plate-comb viscometer, for example from Themo Haake, have the viscosity measured in the above ranges at a shear rate of 1/60 sec⁻¹.

The aqueous pigment preparations of the present invention are miscible with water in any proportion in that even two or more different preparations can be mixed with water. They have outstanding stability in storage compared with conventional pigment preparations and are notable for a very low tendency to agglomerate and sediment. The pigment preparations possess a high color yield, defined hues, high colorfastness to light, high bleed resistance and good rheological properties.

The present invention also provides a process for producing the pigment preparations of the present invention, which comprises dispersing component (A) in the form of a powder, a granulate or an aqueous presscake in the presence of water (G) and also of components (B), (C), (D), (E) and (F) in a conventional manner, then admixing water, if appropriate, and adjusting the resulting aqueous pigment dispersion to the desired concentration with water. Preferably, the components (B), (C), (D), (E) and (F) are mixed and homogenized and then component (A) is stirred into the initially charged mixture, causing the pigment to become incipiently pasted and predispersed. The predispersion is subsequently finely dispersed or divided using a grinding or dispersing assembly, depending on the texture of the pigments used, with or without cooling. Stirrers, dissolvers (sawtooth stirrers), rotor-stator mills, ball mills, stirred media mills such as sand and bead mills, high-speed mixers, kneaders, roller mills or high-performance bead mills can be used for this. The pigments are ground/finely dispersed to the desired particle size distribution, at temperatures ranging from 0 to 100° C., advantageously at a temperature between 10 and 70° C. and preferably at from 20 to 60° C. Following the operation of fine dispersal, the pigment preparation may be further diluted with water, preferably deionized or distilled water.

The pigment preparations of the present invention are useful for pigmenting and coloring macromolecular materials of any kind, for example natural and synthetic fiber materials, preferably cellulose fibers, especially for paper pulp coloration, particularly for laminate coloration.

The pigment preparation of the present invention is particularly useful for pigmentation/production of coating compounds, emulsion paints, latex paints, printing inks, for example printing inks for textile, flexographic, decorative or gravure printing, wallpaper colors, water-thinnable paints, wood stains, wood preservation systems and paints for surface coating of objects made for example of metal, wood, plastic, glass, ceramic, concrete, textile material, paper or rubber.

### EXAMPLES

Producing a Pigment Preparation

The pigment in the form alternatively of powder, granulate or presscake is pasted in deionized water together with the dispersing agents and the other adjuvants and then homogenized and predispersed using a dissolver (for example an AE3-M1 from VMA-Getzmann GmbH) or some other suitable apparatus. The subsequent fine dispersal is effected using a bead mill (for example AE3-M1 from VMA-Getzmann) or else some other suitable dispersing assembly, by grinding with siliquartzite beads or zirconium mixed-oxide beads d=1 mm in size, under cooling, until the desired color strength and coloristics are obtained. Thereafter, the dispersion is adjusted with deionized water to the desired final pigment concentration, the grinding media are separated off and the pigment preparation is isolated.

The pigment preparations described in the examples which follow were produced by the method described above, the following constituents being used in the stated amounts so as to produce 100 parts of the particular pigment preparation. Parts are by weight in the examples below.

### Example 1

| | | |
|---|---|---|
| 18 | parts | of C.I. Pigment Green 7 (Hostaperm ® Green GNX, |
| | | component A), |
| 12 | parts | of wetting and dispersing additive (Dispersogen ® AN 100, |
| | | component B), |
| 1 | part | of water-swellable crosslinked copolymer comprising |
| | | 94 wt % of 2-acrylamido-2-methyl-1-propanesulfonic acid, |
| | | partially neutralized with ammonia, 5 wt % of N-vinyl- |
| | | pyrrolidone and 1% of trimethylolpropane triacrylates |
| | | (component C), |
| 0.5 | part | of defoamer (Antimussol ® NS 22, component D), |
| 0.2 | part | of preservative (Nipacide ® BSM, component E), |
| 68.3 | parts | of water (component G) |

The components (B), (C), (D), (E) and (G) are initially charged to a grinding vessel and mixed. Then, the pulverulent component (A) is added and predispersed using the dissolver. The fine dispersal is effected in a bead mill using zirconium mixed-oxide beads d=1 mm in size under cooling. The grinding media are subsequently separated off and the pigment preparation is isolated. The pigment preparation is stored at 60° C. for one week and visually inspected. The viscosity of the pigment preparation is measured using a Brookfield DV-II digital viscometer at 100 revolutions per minute of spindle 4.

The pigment preparation is liquid, homogeneous and foam-free after one week of storage at 60° C. The viscosity of the pigment preparation is 177 mPa·s.

### Example 2 (Comparative Example)

| | | |
|---|---|---|
| 18 | parts | of C.I. Pigment Green 7 (Hostaperm ® Green GNX, |
| | | component A), |
| 12 | parts | of wetting and dispersing additive (Dispersogen ® AN 100, |
| | | component B), |
| 0.5 | part | of defoamer (Antimussol ® NS 22, component D), |
| 0.2 | part | of preservative (Nipacide ® BSM, component E), |
| 69.3 | parts | of water (component G) |

The pigment preparation is produced and tested as described under Example 1. The pigment preparation is liquid and foam-free after one week of storage at 60° C. The viscosity of the pigment preparation is 6 mPa·s and there is some pigment sedimentation.

### Example 3

| | | |
|---|---|---|
| 6 | parts | of C.I. Pigment Blue 15:3 (Hostaperm ® Blue B2G, |
| | | component A), |
| 3 | parts | of wetting and dispersing additive (Dispersogen ® LFS, |
| | | component B), |
| 1 | part | of water-swellable crosslinked copolymer from Example 1 |
| | | (component C), |
| 0.5 | part | of defoamer (Antimussol ® NS 22, component D), |
| 0.2 | part | of preservative (Nipacide ® BSM, component E), |
| 89.3 | parts | of water (component G) |

The pigment preparation is produced and tested as described under Example 1. The pigment preparation is liquid, homogeneous and foam-free after one week of storage at 60° C. The viscosity of the pigment preparation is 450 mPa·s.

### Example 4

| | | |
|---|---|---|
| 6 | parts | of C.I. Pigment Black 7 (Printex ® 300, Evonik AG, |
| | | component A), |
| 6 | parts | of wetting and dispersing additive (Dispersogen ® LFS, |
| | | component B), |
| 1 | part | of water-swellable crosslinked copolymer from Example 1 |
| | | (component C), |
| 0.5 | part | of defoamer (Antimussol ® NS 22, component D), |
| 0.2 | part | of preservative (Nipacide ® BSM, component E), |
| 86.3 | parts | of water (component G) |

The pigment preparation is produced and tested as described under Example 1. The pigment preparation is liquid, homogeneous and foam-free after one week of storage at 60° C. The viscosity of the pigment preparation is 95 mPa·s.

### Example 5

| | | |
|---|---|---|
| 6 | parts | of C.I. Pigment Yellow 3 (Hansa ® Yellow 10G, |
| | | component A), |
| 3 | parts | of wetting and dispersing additive (Dispersogen ® LFS, |
| | | component B), |
| 1 | part | of water-swellable crosslinked copolymer from Example 1 |
| | | (component C), |
| 0.5 | part | of defoamer (Antimussol ® NS 22, component D), |
| 0.2 | part | of preservative (Nipacide ® BSM, component E), |
| 92.3 | parts | of water (component G) |

The pigment preparation is produced and tested as described under Example 1. The pigment preparation is liquid, homogeneous and foam-free after one week of storage at 60° C. The viscosity of the pigment preparation is 210 mPa·s.

### Example 6

| | | |
|---|---|---|
| 10 | parts | of C.I. Pigment Yellow 74 (Hansa ® Brilliant Yellow 5GX, |
| | | component A), |
| 5 | parts | of wetting and dispersing additive (Dispersogen ® LFS, |
| | | component B), |
| 1 | part | of water-swellable crosslinked copolymer from Example 1 |
| | | (component C), |
| 0.5 | part | of defoamer (Antimussol ® NS 22, component D), |
| 0.2 | part | of preservative (Nipacide ® BSM, component E), |
| 83.3 | parts | of water (component G) |

The pigment preparation is produced and tested as described under Example 1. The pigment preparation is liquid, homogeneous and foam-free after one week of storage at 60° C. The viscosity of the pigment preparation is 170 mPa·s.

### Example 7

| | | |
|---|---|---|
| 2 | parts | of C.I. Pigment Violet 23 (Hostaperm ® Violet RL 02, |
| | | component A), |
| 2 | parts | of wetting and dispersing additive (Dispersogen ® LFS, |
| | | component B), |
| 1 | part | of water-swellable crosslinked copolymer from Example 1 |
| | | (component C), |
| 0.2 | part | of preservative (Nipacide ® BSM, component E), |
| 94.8 | parts | of water (component G) |

The pigment preparation is produced and tested as described under Example 1. The pigment preparation is liquid, homogeneous and foam-free after one week of storage at 60° C. The viscosity of the pigment preparation is 230 mPa·s.

### Example 8

| | | |
|---|---|---|
| 10 | parts | of C.I. Pigment Red 168 (Hostaperm ® Scarlet GO, |
| | | component A), |
| 5 | parts | of wetting and dispersing additive (Dispersogen ® LFS, |
| | | component B), |
| 1 | part | of water-swellable crosslinked copolymer from Example 1 |
| | | (component C), |
| 0.5 | part | of defoamer (Antimussol ® NS 22, component D), |
| 0.2 | part | of preservative (Nipacide ® BSM, component E), |
| 83.3 | parts | of water (component G) |

The pigment preparation is produced and tested as described under Example 1. The pigment preparation is liquid, homogeneous and foam-free after one week of storage at 60° C. The viscosity of the pigment preparation is 150 mPa·s.

### Example 9

| | | |
|---|---|---|
| 3 | parts | of C.I. Pigment Yellow 42 (Bayferrox ® Yellow 3920, |
| | | Lanxess, component A), |
| 3 | parts | of wetting and dispersing additive (Dispersogen ® LFS, |
| | | component B), |
| 1 | part | of water-swellable crosslinked copolymer from Example 1 |
| | | (component C), |
| 0.3 | part | of defoamer (D-Foam-R C 740, component D), |
| 0.2 | part | of preservative (Nipacide ® BSM, component E), |
| 92.5 | parts | of water (component G) |

The pigment preparation is produced and tested as described under Example 1. The pigment preparation is liquid, homogeneous and foam-free after one week of storage at 60° C. The viscosity of the pigment preparation is 310 mPa·s.

### Example 10

| | | |
|---|---|---|
| 3 | parts | of C.I. Pigment Red 101 (Bayferrox ® Red 130, Lanxess, |
| | | component A), |
| 3 | parts | of wetting and dispersing additive (Dispersogen ® ECS, |
| | | component B), |
| 1 | part | of water-swellable crosslinked copolymer from Example 1 |
| | | (component C), |
| 0.3 | part | of defoamer (D-Foam-R C 740, component D), |
| 0.2 | part | of preservative (Nipacide ® BSM, component E), |
| 92.5 | parts | of water (component G) |

The pigment preparation is produced and tested as described under Example 1. The pigment preparation is liquid, homogeneous and foam-free after one week of storage at 60° C. The viscosity of the pigment preparation is 220 mPa·s.

What is claimed is:

1. An aqueous pigment preparation comprising
(A) 1 to 75 wt % of an organic or inorganic white or color pigment or of a mixture of various organic or inorganic white or color pigments,
(B) 0.01 to 40 wt % of one or more wetting and dispersing additives,
(C) 0.01 to 5 wt % of a water-soluble or water-swellable crosslinked copolymer comprising 50 to 98.99 wt % of acrylamidoalkylsulfonic acid and its salts of formula (I), 1 to 49.99 wt % of cyclic N-vinyl-carboxamides of formula (II) and 0.01 to 8 wt % of a crosslinking monomer having two or more olefinically unsaturated units, 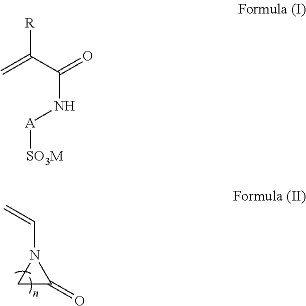
where
R is a hydrogen atom or a methyl radical,
A is a linear or branched alkylene radical with 1 to 8 carbon atoms,
M is a hydrogen atom, ammonium or an alkali metal ion,
n is an integer from 2 to 9.

2. The aqueous pigment preparation as claimed in claim 1 comprising up to 2 wt % of at least one defoamer.

3. The aqueous pigment preparation as claimed in claim 1 and/or 2 comprising up to 2 wt % of at least one biocide.

4. The aqueous pigment preparation as claimed in one or more of claims 1-3 comprising up to 20 wt % of further auxiliaries which are customary for the production of pigment preparations and selected from solvents, humectants, pH regulators, preservatives, defoamers and rheology modifiers.

5. The aqueous pigment preparation as claimed in one or more of claims 1-4 wherein A is an alkylene radical having 2-5 carbon atoms.

6. The aqueous pigment preparation as claimed in one or more of claims 1-5 wherein n is 3, 4 or 5.

7. The aqueous pigment preparation as claimed in one or more of claims 1-6 comprising water ad 100 wt %.

8. The use of a water-soluble or water-swellable crosslinked copolymer comprising 50 to 98.99 wt % of acrylamidoalkylsulfonic acid and its salts of formula (I), 1 to 49.99 wt % of cyclic N-vinylcarboxamides of formula (II) and 0.01 to 8 wt % of a crosslinking monomer having two or more olefinically unsaturated units, 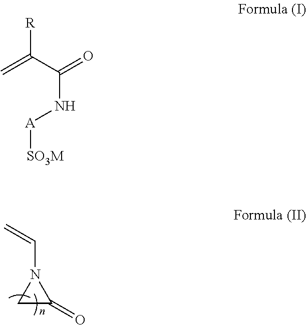
where
R is a hydrogen atom or a methyl radical,
A is a linear or branched alkylene radical with 1 to 8 carbon atoms,
M is a hydrogen atom, ammonium or an alkali metal ion,
n is an integer from 2 to 9,
as a sedimentation stabilizer for aqueous pigment preparations comprising
(A) 1 to 75 wt % of an organic or inorganic white or color pigment or of a mixture of various organic or inorganic white or color pigments,
(B) 0.01 to 40 wt % of one or more wetting and dispersing additives.
